(19) United States
(12) Patent Application Publication
(10) Pub. No.: US 2006/0235681 A1
(43) Pub. Date: Oct. 19, 2006

(54) Adaptive pulse allocation mechanism for linear-prediction based analysis-by-synthesis coders

(75) Inventors: Kuo-Guan Wu, Miaoli County (TW); Shi-Han Chen, Taipei City (TW); Shun-Ju Chen, Kaohsiung County (TW); Shih-Ming Huang, Kaohsiung County (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/272,773

(22) Filed: Nov. 15, 2005

(30) Foreign Application Priority Data
Apr. 14, 2005 (TW) 94111805

(51) Int. Cl. G10L 19/12

(52) U.S. Cl. 704/223

(57) ABSTRACT

A scheme of allocating variable pulses for each frame is proposed to reduce the bit-rate of LP based AbS coders while maintaining the same speech quality. Since speech signal is not stationary, the required pulse count in a speech coder should be variable frame by frame. In this patent the optimal pulse count allocation is provided based on criterion of perceptual distortion analysis. The method comprises receiving source speech data and generating temporary encoded data according to the source speech data, and synthesized speech data according to the temporary encoded data, and adjusting the fixed codebook pulse allocation in temporary encoded data to a minimum required pulse count according to the perceptual disturbance values between the synthesized speech data and the source speech data, and outputting final encoded data accordingly.

### BACKGROUND

The invention relates to speech coders, and more particularly, to an adaptive pulse allocation mechanism based on perceptual distortion analysis, and can be used to reduce bit-rate of linear-prediction (LP) based analysis-by-synthesis (AbS) coders while maintaining the same speech quality.

LP based AbS structure, which was discussed in the article, entitled “A New Model of LPC Excitation for Producing Natural-Sounding Speech at Low Bit Rates” by Bishnu S. Atal and Joel R. Remde, Proc. ICASSP, pages 614-617, 1982, is the most successful and commonly used technique in modern speech codecs. In that work the excitation of each frame was given by a fixed number of pulses, which is known as Multi-Pulse Excited (MPE) codec. However, many different representations of excitation existed. The most well known representations are Regular-Pulse Excited (RPE) codec which is adopted in GSM system and Code Excited Linear Prediction (CELP) codecs which is included in several important ITU-T standards such as G.723.1 5.3 kbps, G.729 (8 kbps), and G.728 (16 kbps) . CELP coders can achieve toll-quality encoding of speech signals at bit-rates above 6 kbps. However, at lower bit-rates, due to shortage of bits for encoding fixed codebook (FCB) excitation, voice quality of CELP coders becomes poor.

FIG. 1 is a block diagram of a conventional speech encoder and decoder. Encoded data Sc(n) is produced by encoding input speech data Si(n). Encoded data Sc(n) comprises adaptive codebook (ACB) parameter SA representing periodic component of excitation, FCB parameter SF representing random component of excitation, and LP synthesis parameter SS. Encoded data Sc(n) is decoded and speech data S_{D}(n) is reconstructed by a decoder 12. Decoder 12 comprises an ACB mean 121 receiving the ACB parameter SA, a FCB mean 122 receiving the FCB parameter SF, and a linear prediction (LP) synthesis filter 123 receiving the LP synthesis parameter is SS. The output of ACB mean 121 and FCB mean 122 is combined to form the quantized version of excitation signal and then passed to the LP synthesis filter 123 which generates the reconstructed speech data S_{D}(n).

TABLE 1
Bit allocation table of G723.1, 6.3k bits/s codec

| Parameters | Subframe | Subframe | Subframe | Subframe | |
|---|---|---|---|---|---|
| coded | 1 | 2 | 3 | 4 | Total |
| LPC indices | | | | | 24 |
| Adaptive | 7 | 2 | 7 | 2 | 18 |
| codebook lags | | | | | |
| All the gains | 12 | 12 | 12 | 12 | 48 |
| combined | | | | | |
| Pulse positions | 20 | 18 | 20 | 18 | 73 |
| Pulse signs | 6 | 5 | 6 | 5 | 22 |
| Grid index | 1 | 1 | 1 | 1 | 4 |

| | |
|---|---|
| Total | 189 |

random excitation = 73 + 22 + 4 = 99 bits, total = 189 bits

TABLE 2
Bit allocation table of G.729 8k bits/s codec

| | | | | Total |
|---|---|---|---|---|
| | | Subframe | Subframe | per |
| Parameters coded | Code word | 1 | 2 | frame |
| Line spectrum pairs | L0, L1, L2, | | | 18 |
| | L3 | | | |
| Adaptive codebook delay | P1, P2 | 8 | 5 | 13 |
| Pitch delay parity | P0 | 1 | | 1 |
| Fixed codebook index | C1, C2 | 13 | 13 | 26 |
| Fixed codebook sign | S1, S2 | 4 | 4 | 8 |
| Codebook gains(stage 1) | GA1, GA2 | 3 | 3 | 6 |
| Codebook gains(stage 2) | GB1, GB2 | 4 | 4 | 8 |

| | |
|---|---|
| Total | 80 |

random excitation = 26 + 8 = 34 bits, total = 80 bits

Table 1 and Table 2 are bit allocation tables for G.723.1 6.3 kbps and G.729 8 kbps. The random excitation component, which is represented by fixed codebook, occupies about half of the total encoded bitstream. If we can properly reduce the FCB pulses number without compromising speech data quality, encoded data size could be significantly reduced.

PESQ (Perceptual evaluation of speech quality), which is defined in ITU-T Recommendation P.862, is an objective measurement tool that predicts the results of subjective listening tests on speech that is distorted by channels, codecs, or noises. PESQ uses a sensory model to compare the original, unprocessed signal with degraded signal from the network or network element. For a given source utterance and a corresponding degraded utterance, PESQ calculate a frame disturbance sequence between the two utterances and use these disturbance values to predict the objective PESQ MOS score. The average correlation between the objective scores and subjective “Mean Opinion Score” (MOS) measured using panel tests according to ITU-T P.800 is 0.935. PESQ provides a quality control criterion for sound quality verification.

Many previous works were focused on representing excitation more efficiently. Some LP based AbS coders, such as RPE and CELP coders, limit the pulse positions by some simple rules, and have limited success in reducing the bit-rate of FCB excitation. Some conventional methods limit pulse positions by exploiting the energy distribution and the periodicity of FCB pulses. However, these properties were only applicable for encoding voiced and transition frames, and therefore limits the reduction of FCB bit-rate, and an additional voice type classifier is required. Some other conventional methods utilize time-varying characteristic of speech and adapt corresponded strategies for encoding each types of speech, which also requires additional robust voice type classifiers.

### SUMMARY

A scheme of allocating variable pulses in each frame of speech data is proposed to reduce the bit-rate of LP based AbS coders while maintaining the same speech quality. Since speech signal is not stationary, the required pulse count for a speech coder can be variable frame by frame. Optimal pulse count allocation is provided based on criterion of perceptual distortion analysis. The method is provided, comprising receiving source speech data, generating temporary encoded data according to the source speech data, and synthesizing speech data according to the temporary encoded data, and adjusting the fixed codebook pulse allocation in the temporary encoded data to a minimum required pulse count according to the perceptual disturbance values between the synthesized speech data and the source speech data, and outputting final encoded data accordingly.

### DESCRIPTION OF THE DRAWINGS

The accompanying drawings, incorporated in and is constituting a part of this specification, illustrate embodiments of the invention and, together with the description, serve to explain the features, advantages, and principles thereof.

FIG. 1 is a block diagram of a conventional LP based AbS speech encoding and decoding system.

FIG .2 is a block diagram of an LP based AbS speech encoding device 20 according to an embodiment of the invention.

FIG. 3 illustrates the P.862 score improvement when increasing the pulse count of a frame by one v.s. the corresponding decrease of overall frame disturbance value of a G.723.1 6.3 kbps (MPE) transcoded speech.

FIG. 4 illustrates the PESQ score v.s. iteration of a female sentence speech data by setting N to a fixed value 1 and 20.

FIG. 5 illustrates the statistic of the overall decrease of disturbance from frame 1 to frame I v.s. I when increasing the pulse count by one at frame 1.

FIG. 6 is a block diagram of a LP based AbS speech decoding device 30 according to an embodiment of the invention.

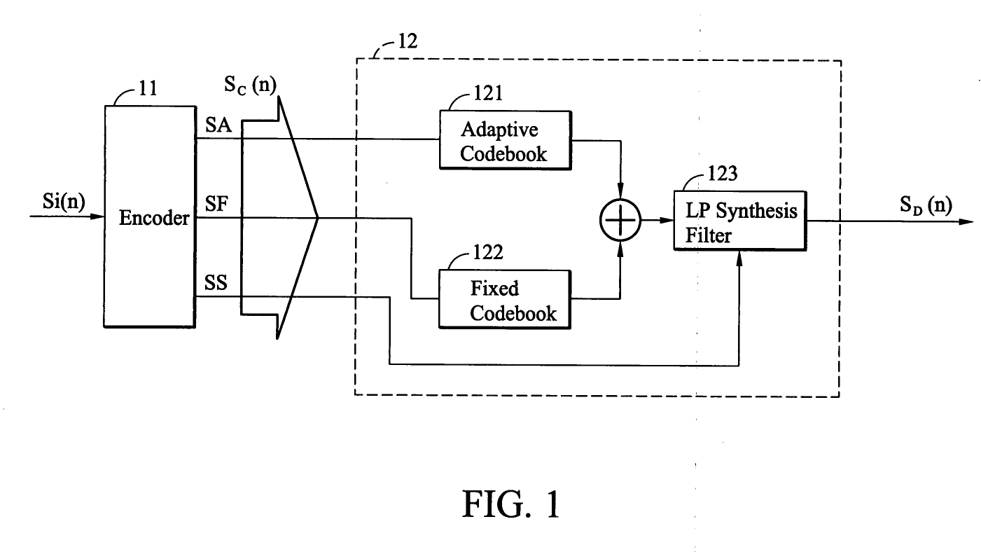

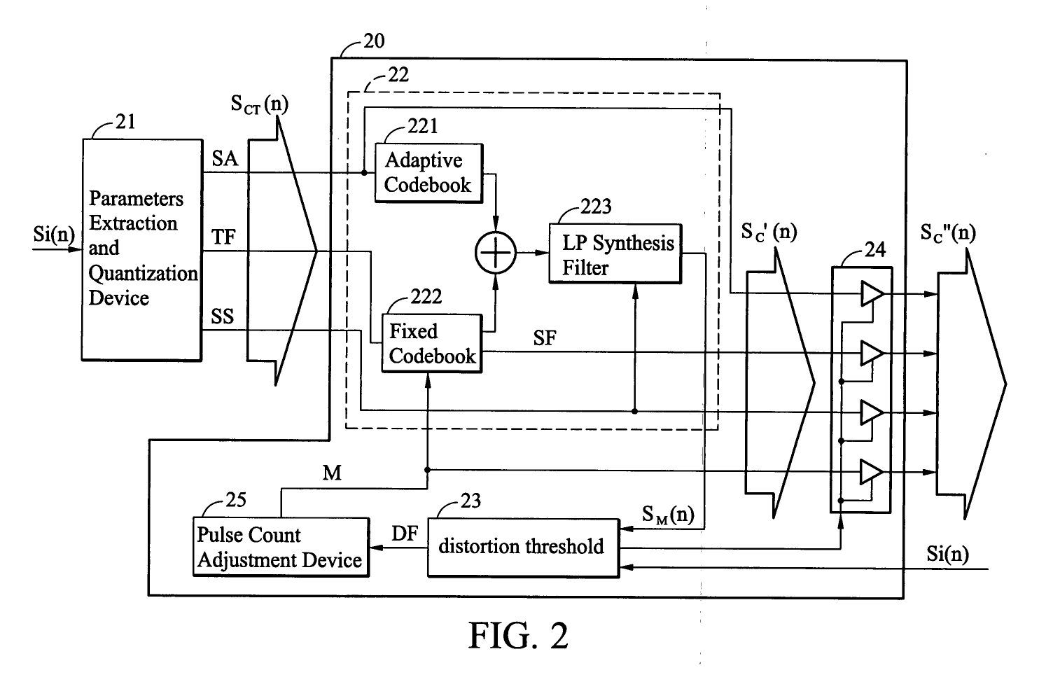

### DETAILED DESCRIPTION

FIG. 2 is a block diagram of an LP based AbS speech encoding device 20 according to an embodiment of the invention. Input source speech data Si(n) is first encoded by parameters extraction and quantization device 21 which produces source encoded data S_{CT}(n) comprising ACB parameter SA, target random excitation signal TF and LP synthesis parameter SS. Source encoded data S_{CT}(n) is delivered to an speech decoding device 22 comprising an ACB mean 221 receiving ACB parameter SA, a FCB mean 222 receiving target random excitation signal TF, and a LP synthesis filter 223 receiving LP synthesis parameter SS. A frame of speech data is processed in this embodiment.

Note that the invention is applicable for any LP based AbS encoding system. Parameters extraction and quantization device 21 may be part of any conventional LP based AbS encoder. Speech decoding device 22 also utilizes a conventional LP based AbS decoder structure with a FCB mean 222 using variable pulse allocation. FCB mean 222 further receives a pulse count M for each frame and generates a FCB parameter SF, by choosing M best pulses to approximate the target random excitation signal TF. Temporary encoded data Sc′(n) is then generated by combining ACB parameter SA, FCB parameter SF, LP synthesis parameter SS, and pulse count M. LP synthesis filter 223 receives a combination of periodic excitation component generated by ACB mean 221 and random excitation component generated by FCB mean 222, and generates synthesized speech data S_{M}(n), which corresponds to the temporary encoded data Sc′(n).

Note that during the encoding process, FCB mean 222 not only receives target random excitation signal TF and pulse count M and generates a FCB parameter SF, but also generates quantized version of random excitation component according to FCB parameter SF. In this embodiment, a frame of speech data is processed each time with all sub-frames using the same pulse count M.

Perceptual distortion analysis device 23 derives perceptual disturbance value DF of each frame between the synthesized speech data S_{M}(n) and the input speech data Si(n). Any perceptual model and perceptual distance measure can be used to derive the perceptual disturbance values and in this embodiment ITU P.862 is adopted, although the disclosure is not limited thereto. Since the minimum required pulse count in different parts of speech to maintain the same speech quality may not be the same, the perceptual disturbance values DF provide a criterion for pulse count adjustment device 25 to allocate the minimum required pulse count of each frame. However, since the coding process is not independent across frames, it is hard to derive the optimal solution of pulse count allocation directly from the perceptual disturbance values. Instead we use an iterative adjustment of pulse count and try to find a sub-optimal solution. In this embodiment, multi-frame speech data, e.g. a chunk of speech data, is processed each time.

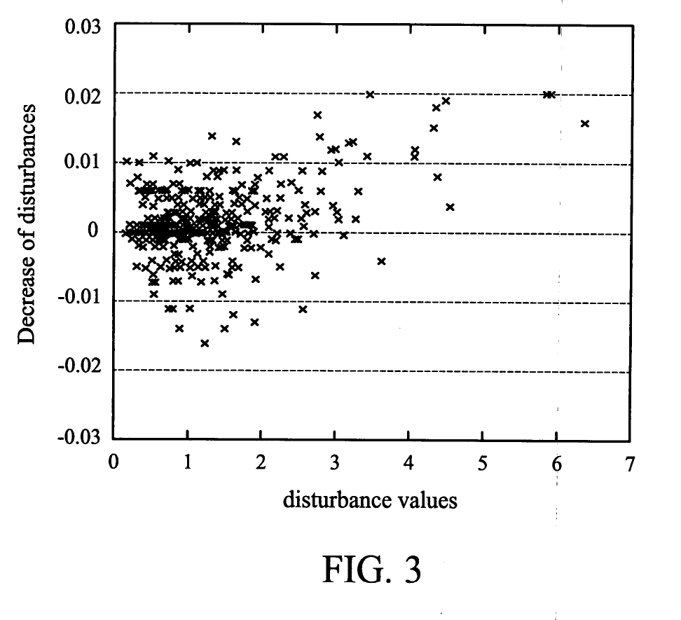

In the pulse count adjustment device 25, the pulse count of each frame is first initialized to the minimum value defined in the LP based AbS speech codec being concerned. Next in each iteration N frames are chosen to increase their allocated pulse count by one. FIG. 3 illustrates the P.862 score improvement when increasing the pulse count of a frame by one v.s. the corresponding decrease of overall frame disturbance value of a G.723.1 6.3 kbps (MPE) transcoded speech. As shown, when a frame has a larger disturbance value, it tends to have a larger improvement when its pulse count is increased. On the other hand, increasing the pulse counts of frames with smaller disturbances may lead to decrease in PESQ score. Therefore, N frame with largest frame disturbances are chosen in the pulse count adjustment device 25 to increase pulse counts in every iteration stage. FCB mean 222 then calculates new FCB parameters SF according to the allocated pulse counts, and generate new random excitation component. Synthesized speech data S_{M}(n) and temporary encoded data Sc′(n) are also updated, and perceptual distortion analysis device 23 again derives the perceptual disturbance values DF between the new synthesized speech data S_{M}(n) and source speech data Si(n).

To decide when to stop the iteration process, a controller (not shown) in the perceptual distortion analysis device 23 first receives the distortion threshold PESQ score S₁. The distortion threshold is the perceptual distortion between the input speech data Si(n) and the speech data which is transcoded by a conventional LP based AbS coder with standard pulse count configuration. The iteration will stop when PESQ score of S_{M}(n) is equal or larger than S₁, which means its objective speech quality is similar with that of the standard. Controller in the perceptual distortion analysis device 23 then directs output control device 24 to output temporary encoded data Sc′(n) and pulse count M as final encoded data Sc″(n). Pulse count M used by FCB mean 222 is minimum for encoding speech data with similar quality. Final encoded data Sc″(n) comprises ACB parameter SA, FCB parameter SF, synthesized parameter SS and pulse count M.

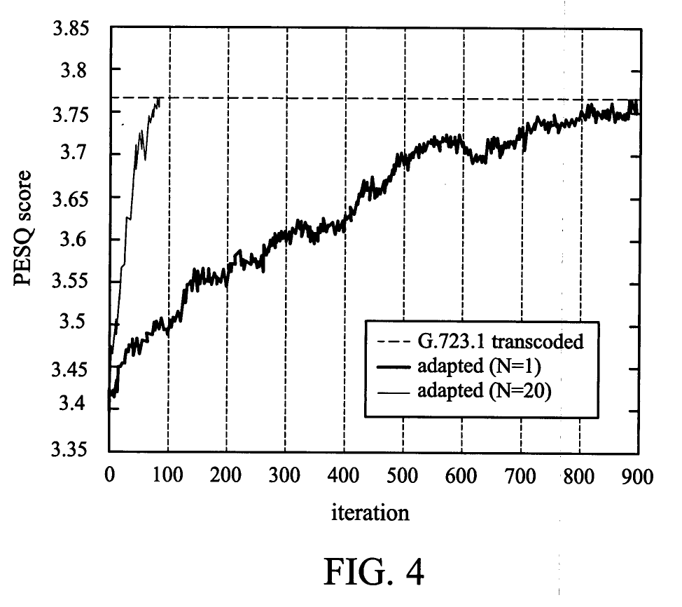

FIG. 4 illustrates the PESQ score v.s. iteration of a female sentence speech data by setting N to a fixed value 1 and 20. As shown, PESQ score of the pulse allocation adapted speech eventually reach that of the standard with a much smaller FCB bits. Experiment results show that the required FCB bits are smallest when N=1 and increase when N grows, while the execution time is much faster with a larger N. It is because when N grows, more frames with smaller disturbances may be chosen and increasing the pulse counts in those frames does not necessary bring score improvement, which is already shown in FIG. 3. Therefore to further reduce the bit-rate in the case of higher N, the most appropriate number of chosen frames should also decrease after some iteration. N then can be initialized to 80 and decrease N when overall disturbance value increase, which means some wrong frames are chosen. Results show that both the FCB bits and execution time are reduced due to the more efficient iteration process.

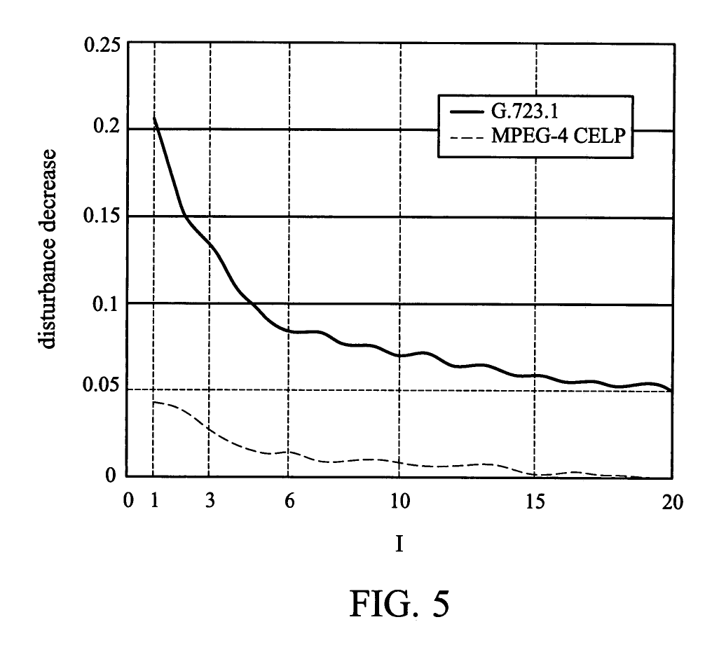

The FCB bits can further be decreased by taking advantage of the inter-frame dependence property in speech codecs. Since encoding of a frame depends on the previous encoded and decoded frame, increasing the pulse count of a frame may also decrease the quantization error produced by FCB in that frame and therefore increase the prediction gain in consecutive frames due to the long-term prediction process. FIG. 5 illustrates the statistic of the overall decrease of disturbance in frame {1 . . . I} v.s. I when increasing the pulse count by one at frame 1. A score 6-norm defined in P.862 is used to calculate the overall decrease in disturbance, which is

$${L}_{6} [ I ] = {( \frac{1}{I} {\sum }_{i = 1}^{I} {disturbance [ i ]}^{6} )}^{1 / 6} \qquad ( 1.1 )$$

As shown, this inter-frame dependence in G.723.1 which is a MPE coder is stronger than MPEG-4 CELP which is a CELP type coder, and clearly the largest improvement locates at I=1. However, the consecutive frames also have some benefit since the overall disturbance also decrease. Therefore, it is chosen the minimum consecutive distances in the chosen N frames to be 6 for G.723.1 and MPEG-4 CELP, which has an overall decrease in disturbance which is about half of that when I=1. The FCB bits are reduced for G.723.1, but not in MPEG-4 CELP. One possible reason is that the inter-frame dependence is so small in MPEG-4 CELP so that preventing pulses from locating in close positions may increase the required FCB pulses to maintain the same quality.

Since a fixed pulse count of encoded data is expected by conventional LP based AbS decoders, a LP based AbS decoder is then provided to decode the encoded data according to the invention. Pulse count M is included in the encoded speech data, and must be recognized by the associated LP based AbS decoders for correct pulse allocation. Pulse count M used by all sub-frames of a frame is contained in the encoded speech data in a predetermined format, for example, at the beginning of each frame with a fixed bit allocation.

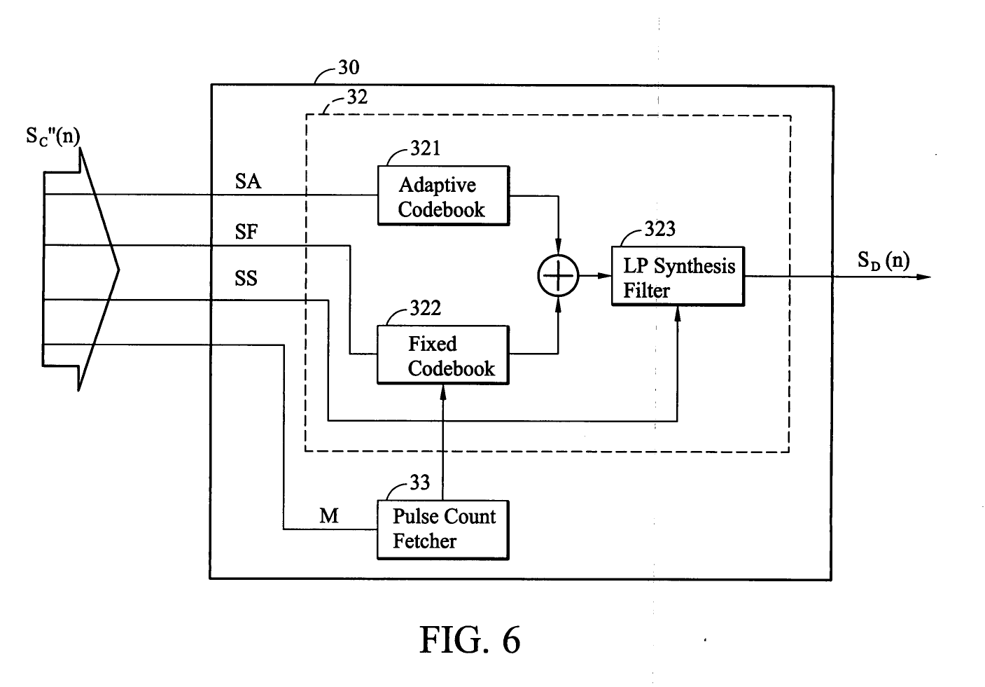

FIG. 6 is a block diagram of a LP based AbS decoding device 30 according to an embodiment of the invention. LP based AbS decoding device 30 comprising a pulse count fetcher 33 extracting the pulse count M from the encoded speech data Sc″(n) and a LP based AbS decoding decoder 32 with a FCB mean receiving the pulse count M for allocate the same number of pulses from the encoded speech data Sc″(n).

When embodiments of the invention are applied to reduce the bit-rate of G.723.1 6.3 kbps (MPE codec) and MPEG-4 CELP (CELP codec), the results show that the proposed scheme can achieve over 30% bit-rate reduction in fixed codebook (FCB) and about 20% in all for both coders while maintaining the same speech quality in both objective and subjective measure. The invention does not require any voice type information and therefore does not need a voice type classifier. Additionally, the invention is shown to be effective for both MPE and CELP based speech coders. Although the complexity of this scheme is larger than the original codecs due to the iteration process, it is acceptable in offline compression of speech and therefore can be used to reduce the footprint of systems with massive stored speech data, such as Text-To-Speech or electronic book systems; application of the invention can ease storage loading significantly.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. A method of adapting pulse allocation for linear-prediction (LP) based analysis-by-synthesis (AbS) coders, comprising
receiving source speech data
generating temporary encoded data according to the source speech data, and synthesized speech data according to the temporary encoded data; and
adjusting the fixed codebbok pulse allocation in the temporary encoded data to a minimum pulse count according to perceptual disturbance values between the synthesized speech data and the source speech data, and outputting final encoded data accordingly.

2. The method as claimed in claim 1, wherein the count of each frame is initialized to a pre-pulse determined minimum value, and increased when the perceptual distortion between the synthesized speech data and the source speech data is larger than a pre-calculated distortion threshold.

3. The method as claimed in claim 2, wherein the distortion threshold is a perceptual distortion between the source speech data and a speech data encoded and decoded thereof by a LP based AbS coder with standard pulse count configuration.

4. The method as claimed in claim 3, wherein the fixed codebook pulse allocation in the temporary encoded data is generated according to target random excitation signal and the pulse count.

5. The method as claimed in claim 2, wherein a chunk of speech data is processed each time.

6. The method as claimed in claim 5, wherein the pulse counts of N frames with highest disturbance values, are increased when the perceptual distortion between the synthesized speech data and the source speech data is larger than the distortion threshold; wherein N is initialized to a predetermined number, and decreased when the perceptual distortion between the synthesized speech data and the source speech data is increased after increasing the pulse counts.

7. The method as claimed in claim 6, wherein minimum consecutive separation frames between any 2 of the N chosen frames are set to a pre-determined value.

8. The method as claimed in claim 7, wherein the pulse counts are stored in the final encoded data when the perceptual distortion between the synthesized speech data and the source speech data is smaller than or equal to the distortion threshold.

9. The method as claimed in claim 2, wherein the pulse count is increased by a predetermined number when the perceptual distortion between the synthesized speech data and the source speech data is larger than a distortion threshold.

10. The method as claimed in claim 1, further comprising outputting the pulse counts of the final encoded data when outputting the final encoded data.

11. The method as claimed in claim 1, wherein the perceptual disturbance values are derived using a psycho-acoustic model and perceptual distance measure.

12. A encoding device adapting pulse allocation for a LP based AbS system, comprising
an encoder with a fixed codebook mean, receiving source speech data and generating temporary encoded data and synthesized speech data according to the temporary encoded data;
an output control device;
a perceptual distortion analysis device receiving source speech data and the synthesized speech data, deriving a perceptual disturbance sequence between the synthesized speech data and source speech data and directing the output control device to output final encoded data accordingly; and
a pulse count adjustment device adjusting the FCB pulse allocation in the temporary encoded data to a minimum required pulse number.

13. The encoding device as claimed in claim 12, wherein the fixed codebook mean derives the fixed codebook parameter of the temporary encoded data according to a target random excitation signal and a pulse count generated by the pulse count adjustment device.

14. The encoding device as claimed in claim 13, wherein the pulse count adjustment device initialize the pulse count to a pre-determined minimum value, and increase the pulse count when a perceptual distortion output of the perceptual distortion analysis device is active.

15. The encoding device as claimed in claim 14, wherein the perceptual distortion output is active when the perceptual distortion between the synthesized speech and the source speech data is higher than a pre-calculated distortion threshold.

16. The encoding device as claimed in claim 15, wherein the pre-calculated distortion threshold is a perceptual distortion between the source speech data and the speech data which is encoded and decoded thereof by the LP based AbS coders with standard pulse count configuration.

17. The encoding device as claimed in claim 12, wherein a chunk of speech data is processed each time; the perceptual distortion analysis device further comprises:
a controller monitoring the perceptual distortion between the synthesized speech data and the source speech data; the pulse counts of N frames with highest disturbance values are increased by the pulse count adjustment device when the perceptual distortion between the synthesized speech data and the source speech data is larger than the distortion threshold; wherein N is initialized to a predetermined number, and decreased when the perceptual distortion is increased after increasing the pulse counts.

18. The encoding device as claimed in claim 17, wherein minimum consecutive separation frames between any 2 of the N chosen frames are set to a pre-determined value.

19. The encoding device as claimed in claim 18, wherein the pulse counts are output when the perceptual distortion between the synthesized speech data and the source speech data is smaller than or equal to the distortion threshold.

20. The encoding device as claimed in claim 12, wherein the pulse count is increased by a predetermined number when the perceptual distortion between the synthesized speech data and the source speech data is larger than a distortion threshold.

21. The encoding device as claimed in claim 12, wherein the pulse count of each frame of the final encoded data is output when outputting the final encoded data.

22. The encoding device as claimed in claim 12, wherein the perceptual disturbance values are derived using a psycho-acoustic model and perceptual distance measure.

23. A decoding device adapting pulse allocation, comprising:
a pulse count fetcher extracting a pulse count value stored in encoded speech data using a predetermined format;
a synthesizer generating synthesized speech data according to the encoded speech data;
a fixed codebook mean generating pulse allocation for the synthesizer according to the extracted pulse count value.

24. The decoding device as claimed in claim 23, wherein the pulse count value is stored in front of each frame of encoded speech data, with a fixed bit allocation.
